(19) United States
(12) Patent Application Publication
(10) Pub. No.: US 2007/0206686 A1
(43) Pub. Date: Sep. 6, 2007

(54) Method and apparatus for performing cyclic-shift diversity with beamforming

(76) Inventors: Frederick W. Vook, Schaumburg, IL (US); Timothy A. Thomas, Palatine, IL (US); Xiangyang Zhuang, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/325,876

(22) Filed: Jan. 5, 2006

(51) Int. Cl. H04K 1/10

(52) U.S. Cl. 375/260

(57) ABSTRACT

Cyclic-shift diversity transmission and optional per-subcarrier transmit beamforming within a same time interval (e.g., OFDM symbol interval) takes place. The CSD transmission technique circularly shifts the IFFT output prior to any cyclic prefix insertion and has the effect of putting a subcarrier and antenna dependent phase shift in the effective channel response from each transmit antenna. To properly perform transmit adaptive array (TXAA) transmission within an OFDM symbol interval that is being circularly shifted by the CSD transmission technique, the TXAA weights will account for the frequency domain phase shift created by the CSD circular shift operation.

### FIELD OF THE INVENTION

The present invention relates generally to beamforming and cyclic-shift diversity and in particular, to a method and apparatus for performing cyclic-shift diversity with beamforming.

### BACKGROUND OF THE INVENTION

Transmit beamforming (sometimes referred to as transmit adaptive array (TXAA) transmission) increases the effective signal-to-noise seen by a receiver device by creating a coverage pattern that tends to be directional in nature (i.e., not uniformly: broadcast). This is accomplished by employing multiple antennas at the transmit site and weighting each antenna such that the combined transmissions result in a beamformed pattern having a maximum power in the direction of the receiver. Additionally in the case of transmitting multiple streams to a receiver with multiple receive antennas (i.e., multi-stream TXAA) or to multiple receivers (i.e., transmit spatial division multiple access or SDMA), the antenna weights are computed for both maximum power delivered and minimum cross talk or interference. Transmit beamforming can be deployed on a base station operating in cellular communication systems.

In some circumstances, it is desirable for a base station to transmit data without using transmit beamforming. For example, broadcast transmissions are intended to be received simultaneously by multiple receiving devices scattered throughout a sector of the base station's coverage area. As a result, beamforming is generally not a feasible transmission choice for broadcast data. Also, some transmit beamforming techniques have poor performance in high velocity scenarios; and in such cases, a uniform transmission pattern may be preferable over a beamformed transmission.

In cases where a uniform transmit pattern is desired rather than a beamformed pattern, the base station can simply transmit with only one transmit antenna. However, if low-cost Power Amplifiers (PAs) are deployed behind all the transmit antennas, the base station cannot simply increase the transmit power fed to one transmit antenna to match the total transmit power that can be delivered if all the base antennas can be exploited. As a result, transmitting with only one antenna results in a significant loss in the overall transmit power (⅞ of the power is lost with 8 transmit antennas, ¾ of the power is lost for 4 transmit antennas . . . etc.). On the other hand, sending the same waveform to all transmit antennas causes the effective transmit antenna pattern to have nulls in various fixed locations in the coverage area, which is generally unacceptable for broadcast traffic. In systems such as those based on the IEEE 802.16 standards and its amendments and revisions, for example, data that is either intended to be broadcast uniformly throughout the cell or is otherwise unsuitable for beamforming must in many cases be transmitted in such a way as to be indistinguishable from a single antenna transmission so as to be standards compliant. In this type of situation, a need exists for a method and apparatus for providing a transmit array pattern that is effectively broadcast in nature while providing a transmission format that is indistinguishable from a single antenna transmission. Furthermore, when such a method and apparatus is employed in OFDM-based systems, it would be advantageous to transmit within one OFDM symbol interval data that is to be beamformed on some OFDM subcarriers and data that is to be transmitted with a broadcast characteristic on the other OFDM subcarriers.

### BRIEF DESCRIPTION OF THE DRAWINGS

FIG. 1 is a block diagram of a transmitter.

FIG. 2 illustrates multicarrier transmission.

FIG. 3 is a flow chart showing the operation of the transmitter of FIG. 1.

FIG. 4 is a block diagram of a transmitter.

FIG. 5 is a flow chart showing the operation of the transmitter of FIG. 4.

### DETAILED DESCRIPTION OF THE DRAWINGS

In order to address the above-mentioned need, Cyclic-shift diversity (CSD) is provided for enabling all base station transmit antennas to be active while still maintaining a transmit array pattern that is effectively broadcast in nature. In systems such as those based on the IEEE 802.16e standard, it is intended for CSD transmission to be indistinguishable from a single antenna transmission so as to maintain standards compliance. In an OFDM system, CSD puts a circular shift on an IFFT output on all but the first transmit antenna element prior to cyclic prefix insertion. (It should be noted that equivalently a circular shift can be put on all transmit antennas or that another antenna other than the first may be the antenna where no circular shift is applied).

With CSD being used for broadcast transmissions and TXAA being used for beamforming, a problem arises when both CSD and TXAA are to be used within the same OFDM symbol interval but on different sets of the subcarriers. CSD effectively causes an antenna and subcarrier dependent phase shift in the effective frequency domain channel response between the signals fed to the transmit antennas and the receiver. If the circular shift operation is applied in the time domain right before the IFFT, the resulting phase shift interferes with the ability of the TXAA beamforming weights, which are often applied on OFDM subcarriers in the frequency domain before circular shifting, to deliver maximum power to the receive device. To properly perform transmit adaptive array (TXAA) transmission within an OFDM symbol interval that is being circularly shifted by the CSD transmission technique, the TXAA weights will account for the frequency domain phase shift created by the CSD circular shift operation.

The present invention encompasses an apparatus comprising weighting circuitry for receiving a data stream and outputting the data stream weighted by a stream weight, IFFT circuitry for performing an inverse fast Fourier transform on the weighted data stream and outputting a time-domain data stream, circular shifting circuitry for circular shifting the time-domain data stream by a circular-shift amount, and an antenna transmitting the circular shifted, time-domain data stream.

The present invention additionally encompasses a method comprising the steps of weighting a data stream with a stream weight and performing an IFFT on the weighted data stream to produce a time-domain data stream. The time-domain data stream is circularly shifted by a first circular-shift amount, and the circular-shifted, time-domain data stream is then transmitted.

The present invention additionally encompasses a method comprising the steps of performing a plurality of IFFT operations on data streams to produce a plurality of time-domain antenna streams, circularly shifting at least one time-domain antenna stream by a circular shift amount, and transmitting the time-domain antenna streams via a plurality of antennas.

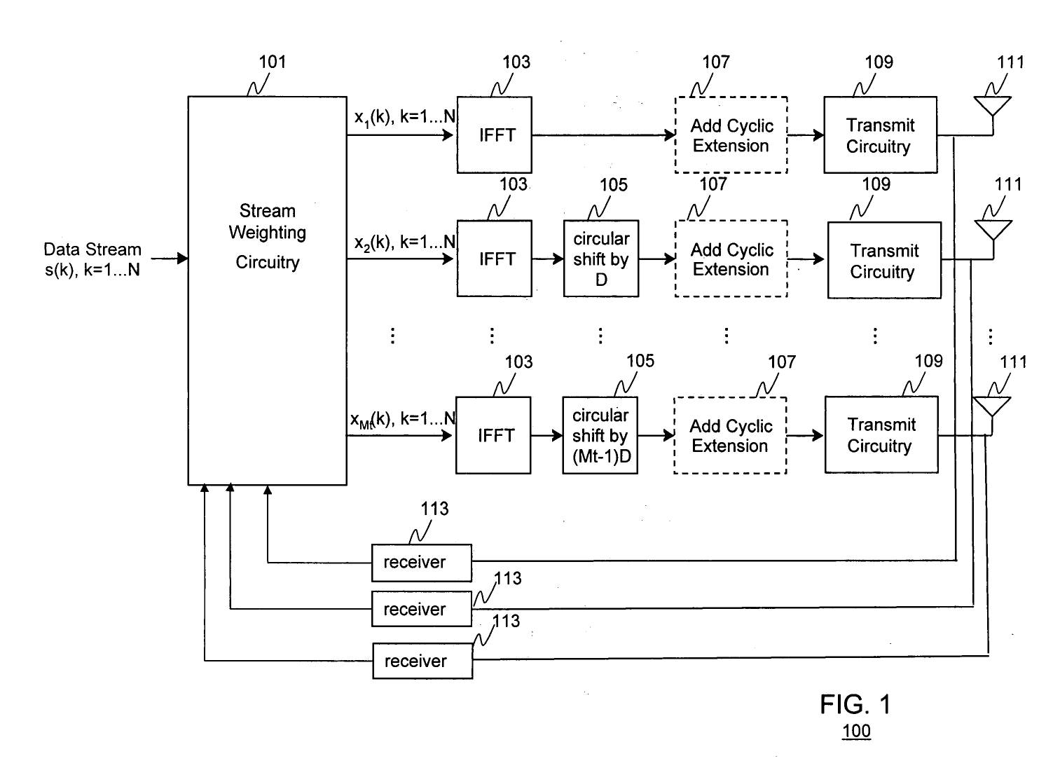

Turning now to the drawings, wherein like numerals designate like components, FIG. 1 is a block diagram of transmitter 100 for performing cyclic-shift diversity with beamforming within a same time interval. In the preferred embodiment of the present invention, communication system 100 utilizes an Orthogonal. Frequency Division Multiplexed (OFDM) or multicarrier based architecture. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. However, in alternate embodiment's communication system 100 may utilize other wideband communication system protocols.

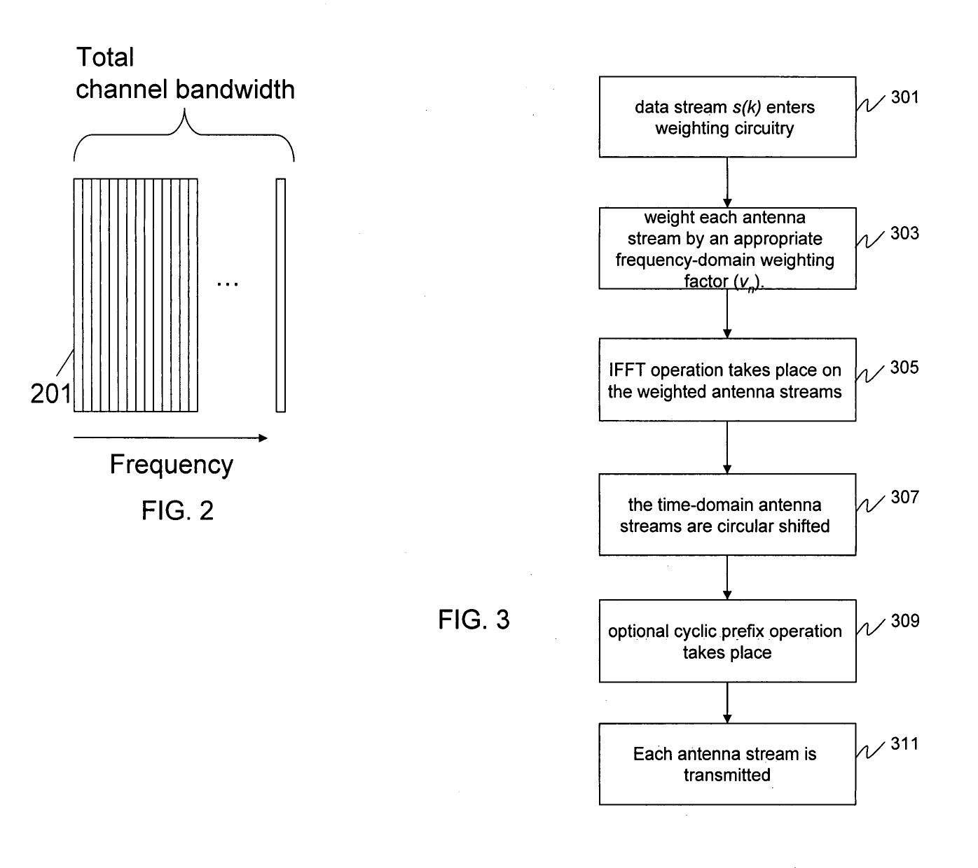

As one of ordinary skill in the art will recognize, during operation of an OFDM system, multiple subcarriers (e.g., 768 subcarriers) are utilized to transmit wideband data. This is illustrated in FIG. 2. As shown in FIG. 2 the wideband channel is divided into many narrow frequency bands (subcarriers) 201, with data being transmitted in parallel on subcarriers 201. As is customary in OFDM, each input to an IFFT corresponds to a subcarrier in the frequency domain. Therefore, a signal that is intended to be transmitted on a given subcarrier is fed to an IFFT input that corresponds to that subcarrier. In the IEEE 802.16 standard on wireless broadband communications, there exist several methods of mapping data to be transmitted to subcarriers or IFFT inputs. The Partial Usage of Subchannels (PUSC) permutation described in the IEEE 802.16 is the subcarrier mapping methodology used on the downlink and uplink MAPs, both of which are sent from the broadcast control channels.

Transmitter 100 comprises stream weighting circuitry 101, inverse Fast Fourier Transform (IFFT) circuitry 103, circular-shift circuitry 105, cyclic prefix circuitry 107 and transmitter 109. During operation a data stream s(k), k=1, 2, . . . N enters stream weighting circuitry 101 (where N is the number of subcarriers). Stream weighting circuitry 101 outputs a plurality of weighted data streams, and in particular, one weighted data stream per antenna. Each weighted data stream (alternatively referred to as “antenna stream”) is appropriately weighted in the frequency domain by an antenna-specific weight vₙ where n=1, 2, . . . T, where T is the number of antennas 111. The weights may also be different on each beamformed subcarrier. Assuming vₘ(k) is the weight for antenna m and subcarrier k, then stream weighting circuitry 101 outputs weighted data/antenna stream xₘ(k)=vₘ(k)s(k) for antenna m. In the case where the data on some of the subcarriers is not to be beamformed, the data/antenna stream s(k) for those subcarriers are fed directly into the k^{th} subcarrier as the input to the IFFT. In other words, on those subcarriers, the vₘ(k) are effectively set to one.

IFFT circuitry 103 performs an inverse Fast Fourier Transform on each weighted data stream, converting the frequency-domain data stream into a time-domain data stream. The time domain data streams are then circularly shifted by circuitry 105. Particularly, the output of IFFT circuitry 103 on the m^{th} transmit antenna is circularly shifted by (m-1)D baseband samples prior to cyclic prefix insertion, where D is an integer number. (Note that generally one antenna stream is left un-shifted for implementation reasons, but this is not necessary. Also note that arbitrary shifts can also be employed meaning that the delay between each transmit antenna is not a constant) The result is an effective phase shift αₘ(k) of the frequency domain transmitted signal on antenna m and subcarrier k, where the phase shift is given by:
αₘ(k)=e^{-j2πk(m-1)D/N}

An optional cyclic extension operation is then carried out on the circularly-shifted antenna streams. In particular, a cyclic prefix, or guard interval is added. The cyclic prefix is typically longer than the expected maximum delay spread of the channel. As one of ordinary skill in the art will recognize, the cyclic extension can comprise a prefix, postfix, or a combination of a prefix and a postfix. The cyclic extension is an inherent part of the OFDM communication system. The inserted cyclic prefix makes the ordinary convolution of the transmitted signal with the multipath channel appear as a cyclic convolution when the impulse response of the channel ranges from 0 to L_{CP}, where L_{CP} is the length of the cyclic extension. Finally, the properly weighted, and circularly-shifted antenna data streams are OFDM modulated and transmitted by transmitters 109 from antennas 111.

On the subcarriers in which beamforming is performed, the stream weighting operation causes each antenna stream to have a varying weight associated with it so that the combined transmissions result in a beamformed pattern having a maximum power in the direction of the receiver. As discussed, however, with CSD being used for broadcast transmissions and TXAA being used for beamforming, a problem arises when both CSD and TXAA are to be used within the same OFDM symbol interval. The CSD approach causes an antenna and subcarrier dependent phase shift in the frequency domain on all subcarriers, whether they are used for beamforming or not, and this phase shift interferes with the ability of the TXAA beamforming weights to deliver maximum power to the receive device. Particularly, on the subcarriers in which TXAA beamforming is to be performed, the TXAA beamforming process has an extra phase shift that results from the time-domain circular shift operation.

In order to address this issue, in the preferred embodiment of the present invention the stream weighting circuitry accounts for the circular shift, and compensates any weighting based on the circular shift amount. More particularly, the phase shift of each antenna due to circular shifting is removed from each stream weight by weighting circuitry 101. Weighting circuitry 101 accounts for the “extra” phase shift that shows up on each subcarrier because of the time-domain circular shift after the IFFT.

For stream weighting circuitry 101 to account for the extra phase shift caused by circular shifting circuitry 105, weighting circuitry 101 must know how much “extra” shift will be introduced by the circular shifting operation. There are multiple ways that stream weighting circuitry may be provided this information, some of which are summarized below:

Option 1: Beamforming Weights Based on Uplink Channel Sounding

This first option can be applied to a base station of time-division duplex (TDD) cellular system in which the uplink and downlink of the system occupy the same frequency bandwidth. An example for this option is the IEEE 802.16e system in which the uplink channel sounding feature is used by a subscriber station to enable the BS to measure the uplink channel response (see Section 8.4.6.2.7 of the IEEE 802.16e/D12 draft specification). The base station antenna array is assumed to be calibrated in such a way that the base station is able to determine the downlink channel response that corresponds to the uplink channel response measured from the uplink channel sounding operation. Techniques for this form of antenna array calibration for TDD systems (called reciprocity calibration) are known in the art and provide the antenna array with a means of converting a channel response measured on the uplink to the appropriate downlink channel response that can be used to calculate transmit beamforming weights. Typically the computation of the downlink channel is achieved by multiplying the measured uplink channel response by calibration coefficients obtained during the calibration process, as is known in the art. This option is summarized as follows:
1. The Antenna Array Calibration operation is performed according to techniques known in the art. No cyclic shifting of the IFFT output is performed in any of the transmissions used in the procedure for calibrating the antenna array.
2. Uplink Channel Sounding is performed by a receiver (subscriber station for example) to enable transmitter 100 to measure the uplink channel via receiver 113.
3. It is assumed that the downlink RF propagation channel will be similar to the uplink channel. Weighting circuitry 101 then computes the downlink baseband channel by multiplying the calibration coefficients by the measured uplink baseband channel.
4. Weighting circuitry 101 multiplies the downlink baseband channel on the k^{th} subcarrier of the m^{th} antenna by αₘ*(k) (i.e., complex conjugate of αₘ(k)) so as to incorporate into the baseband downlink channel response the effects of the cyclic shift that will be performed after the IFFT. The transmit weights can then be computed based on this baseband downlink channel response that incorporates the phase effects of the cyclic shift operation.
   Option 2: CSD Being Performed all the Time and is Accounted for Through Calibration.
1. Array Calibration is performed with the CSD cyclic shift being performed on any downlink transmissions involved in the calibration operation. The calibration coefficients computed in this case will be equal to the calibration coefficients computed above in Option 1 multiplied by αₘ(k).
2. The uplink channel sounding procedure measures the uplink channel response from a subscriber.
3. Weighting circuitry 101 then computes the downlink channel response by multiplying the calibration coefficients by the measured uplink channel. This channel response includes the effects of the CSD operation, and therefore the transmit antenna weights computed based on this channel response will not need any further modification. For this option to make sense, the CSD circular shifting operation must be used for any OFDM symbol interval in which beamforming is used on at least one of the subcarriers.
   Option 3: Weights Being Based on Circularly Shifting the Received Uplink Channel Sounding so as to Accommodate for CSD.
1. Array Calibration is performed according to techniques known in the art. No cyclic shifting of the IFFT outputs is performed in any of the transmissions used in the procedure for calibrating the antenna array.
2. The uplink sounding is performed as usual, but the received samples on receivers 113 are circularly shifted by receiver 113 to provide a frequency domain phase shift that is equivalent to that provided by the CSD transmission. (If the symbol interval in which the uplink channel sounding is received contains non-sounding related transmissions, in other words, sounding and non-sounding transmissions are multiplexed in the frequency domain during the same symbol interval, the circular shift operation would have to be accounted for in decoding these non-sounding related transmissions). The result is that the measured uplink channel response includes a phase shift that equals the phase shift that will be produced by the circular shift operation during transmission.
3. Transmitter 101 computes the downlink channel response by multiplying the calibration coefficients by the measured uplink channel. This downlink channel response therefore includes the effects of the CSD operation, and therefore the TXAA weights (or any other transmit antenna array weights) computed based on the result of this multiplication will not need any further modification. For this option to make sense, the CSD circular shifting operation must be used for any OFDM symbol interval in which beamforming is used on at least one of the subcarriers.

Note that in the above options, uplink channel sounding is used to enable the base station to learn the uplink channel response, and the downlink channel response is computed based on the uplink channel response via the use of calibration coefficients. It should be noted that the techniques described herein for TXAA or beamforming are applicable to any other “closed-loop” transmission strategy that operates on an estimate of the channel between the transmit array and the receive antenna(s). Example transmit strategies are multi-stream transmit beamforming, closed-loop Multiple Input Multiple Output (MIMO), transmit spatial division multiple access, transmit nulling steering, etc. Also, there are a variety of methods for determining the downlink channel response that is used for a closed-loop transmission strategy. Any other appropriate technique known in the art can be used to learn the downlink channel response rather than using the combination of uplink channel sounding and calibration, for example, the uplink data transmission itself can be used as a sounding function.

Additionally note that the above options also work in conjunction with alternative reciprocity calibration methodologies such as those that provide a means of converting a receive antenna weight vector, computed for optimizing the receive array pattern, to a transmit antenna weight vector having a transmit pattern that is substantially the same as the receive array pattern. With this form of reciprocity calibration, the computation of the downlink transmit weight vectors is also achieved by multiplying the receive weight vector by calibration coefficients obtained during the calibration process, a process that is known in the art. Furthermore, when this form of reciprocity calibration is used, the steps in the above options can be easily modified to reflect the fact that the calibration process is converting receive weights to transmit weights rather than converting uplink channel responses to downlink channel responses.

Additionally note also that the above options are primarily for TDD systems since array calibration is used as well as uplink sounding. In frequency division duplex (FDD) systems another option is possible to enable CSD to be combined with beamforming and this option is now given. However, it should be noted that this particular option can be used for TDD as well.

Option 4: Weights Based on Feedback of Downlink Channel Measurements Made by the Receiver From Received Pilot Data with CSD Applied

In this option the base station sends frequency-domain pilots symbols on all or a subset of all subcarriers from each of its transmit antennas. Then CSD is applied to the time-domain samples after applying an IFFT to the pilot signals. The steps for this option are as follows:
1. The frequency-domain pilot symbols on each transmit antenna (possibly combined with beamformed or non-beamformed data symbols) are transformed into the time domain via an IFFT to create time-domain samples.
2. The time-domain samples are circularly shifted on each transmit antenna by some predetermined amount (e.g., by (m-1)D where m is the transmit antenna number) to create CSD time-domain samples for each transmit antennas.
3. The CSD time-domain samples are transmitted from each transmit antenna.
4. The receiver receives the transmitted CSD time-domain signals and takes an FFT of the received CSD time-domain samples.
5. The receiver uses the known pilot symbols to estimate the downlink channel to each transmit antenna with CSD being applied.
6. The receiver feeds back the downlink channel for each transmit antenna to the base station (note that this downlink channel measurement accounts for the CSD being applied).
7. The base station beamforms the downlink data using the downlink channel which was fed back.

Finally, there are various means to feedback the channel or channel knowledge to the base station. The first means is for the mobile to quantize the channel and feed back the quantized channel to the base station. In addition, the mobile could calculate the transmit weights themselves and feed them back to the base. Also the mobile could determine a weight vector from a codebook of vectors which the base should use in transmission and this codebook vector (or its index or identifier) can be fed back.

FIG. 3 is a flow chart showing the operation of the transmitter of FIG. 1. The logic flow begins at step 301 where data stream s(k) enters weighting circuitry 101. At step 303, weighting circuitry 101 properly weights each antenna stream by an appropriate frequency-domain weighting factor (vₙ) such that at least one data stream is weighted with a stream weight. As discussed above, the frequency-domain weighting factor is based on a beamforming weight and/or a future circular shift amount ((m-1)D) that the antenna stream will undergo (where m refers to antenna, and D is an integer). The output of weighting circuitry 101 is a plurality of weighted data/antenna streams xₘ(k)=vₘ(k)s(k), where m refers to antenna and k refers to OFDM subcarrier.

Note that the data stream is weighted on one or more of the inputs to the IFFT, which means that not all subcarriers are necessarily being beamformed. In other words, on some subcarriers, the same identical data is fed to the multiple antennas, which can be modeled mathematically by setting vₘ(k) to one on those subcarriers.

IFFT circuitry 103 performs an IFFT operation on the weighted antenna streams xₘ(k) (step 305) to produce time-domain data/antenna streams. The time-domain antenna streams are circularly shifted (step 307). An optional cyclic prefix operation takes place at step 309, and each antenna stream is transmitted via transmitters 109 over antennas 111 at step 311.

It should be noted that in the IEEE 802.16 standard for example, data that is intended for broadcasting to the cell should not be beamformed because to beamform this data would inhibit the ability of some receivers at some locations in the cell to receive the broadcast data. For example, the downlink and uplink MAPs serve as broadcast control channels and are transmitted using the PUSC subcarrier mapping methodology defined in the IEEE 802.16 standard. When the transmitter 100 must transmit the downlink and uplink MAPs in 802.16, the transmitter will perform the mapping of the data to the IFFT inputs according to the PUSC permutation methodology defined in the IEEE 802.16 standard. The subcarriers will be fed to the IFFT inputs on the antennas (where the IFFT inputs on each branch are identical, which is mathematically equivalent to setting all transmit weights on a subcarrier to one), and then perform the IFFT on each antenna branch. Next, the output of the IFFTs are each circularly shifted by (m-1)D, according to the above description, where D is an integer and m refers to the antenna branch. As discussed above, each antenna will be transmitting the circularly-shifted time-domain data such that each antenna is transmitting the data with a particular and unique shift amount (although in some embodiments, the shift amount used on one antenna could be identical to the shift value used on another antenna).

While the above discussion provided for a method and apparatus for performing beamforming with CSD, in an alternate embodiment, no beamforming is performed, with CSD taking place on time-domain data streams.

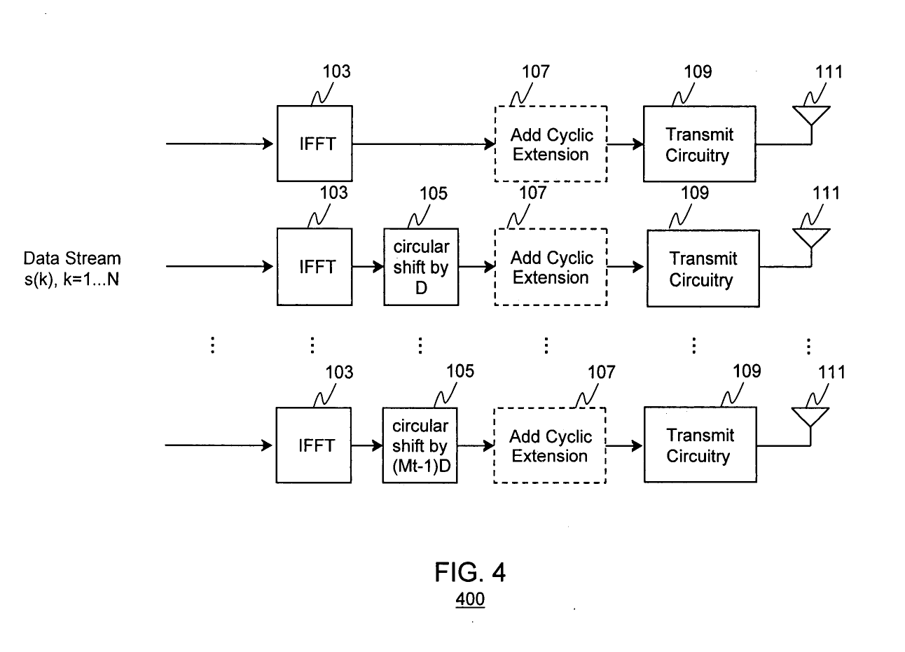

FIG. 4 is a block diagram of transmitter 400 for performing CSD on time-domain data streams. Transmitter 400 comprises inverse Fast Fourier Transform (IFFT) circuitry 103, circular-shift circuitry 105, cyclic prefix circuitry 107, and transmitter 109. During operation a data streams s(k), k=1, 2, . . . N enters each IFFT 103. With no weighting, the vₘ(k) described above are effectively set to one for each antenna stream.

IFFT circuitry 103 performs an inverse Fast Fourier Transform on each un-weighted data stream, converting the frequency-domain data stream into a time-domain data stream. As discussed above, each data stream will be transmitted on a plurality of sub-carriers, with the mapping of the data streams to the sub-carriers taking place via a Partial Usage of Subchannels (PUSC) methodology described in the IEEE 802.16 specification.

The time domain data streams are then circular shifted by circuitry 105. Particularly, the output of IFFT circuitry 103 on the m^{th} transmit antenna is circularly shifted by (m-1)D samples prior to cyclic prefix insertion, where D is an integer number. (Note that generally one antenna stream is left un-shifted). The result is an effective phase shift αₘ(k) of the frequency domain transmitted signal on antenna m of subcarrier k, where the phase shift is given by:
αₘ(k)=e^{-j2πk(m-1)D/N}

An optional cyclic extension operation is then carried out on the circularly-shifted antenna streams. In particular, a cyclic prefix, or guard interval is added. The cyclic prefix is typically longer than the expected maximum delay spread of the channel. As one of ordinary skill in the art will recognize, the cyclic extension can comprise a prefix, postfix, or a combination of a prefix and a postfix. The cyclic: extension is an inherent part of the OFDM communication system. The inserted cyclic prefix makes the ordinary convolution of the transmitted signal with the multipath channel appear as a cyclic convolution when the impulse response of the channel ranges from 0 to L_{CP}, where L_{CP} is the length of the cyclic extension. Finally, the properly weighted, and circularly-shifted antenna data streams are OFDM modulated and transmitted by transmitters 109 over antennas 111. In particular, each antenna will transmit the OFDM data stream, however, each antenna will have its transmission shifted in phase by the circular-shift amount.

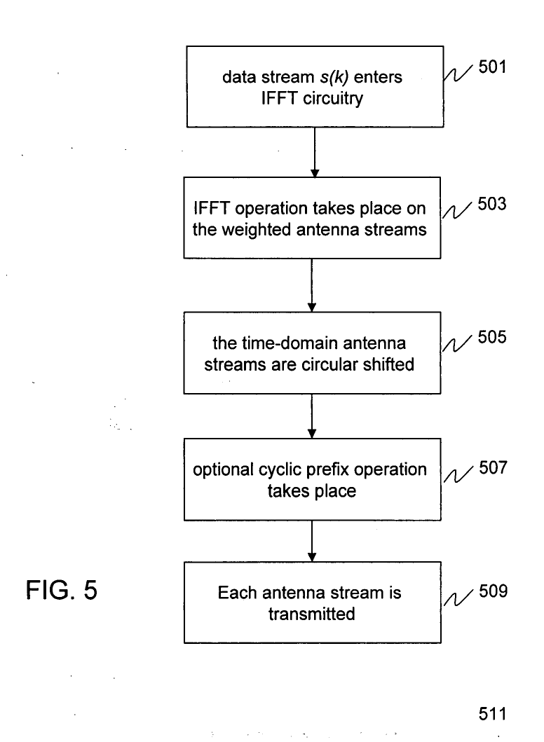

FIG. 5 is a flow chart showing the operation of the transmitter of FIG. 4. The logic flow begins at step 501 where data stream s(k) enters a plurality of IFFT operations (one for each antenna) (step 503) and is converted to the time domain antenna/data stream. The time-domain antenna streams are circular shifted (step 505). An optional cyclic prefix operation takes place at step 507. Each antenna stream is transmitted via transmitters 109 at step 509. As discussed above, each data stream will be transmitted on a plurality of sub-carriers, with the mapping of the data streams to the sub-carriers optionally taking place via a Partial Usage of Subchannels (PUSC) methodology described in the IEEE 802.16 specification. Each antenna will be transmitting the antenna stream that is phase shifted a predetermined amount based on the circular-shift amount.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. An apparatus comprising:
weighting circuitry for receiving a data stream and outputting the data stream weighted by a stream weight;
IFFT circuitry for performing an inverse fast Fourier transform on the weighted data stream and outputting a time-domain data stream;
circular shifting circuitry for circular shifting the time-domain data stream by a circular-shift amount; and
an antenna transmitting the circular shifted, time-domain data stream.

2. The apparatus of claim 1 wherein the stream weight is based on the circular-shift amount.

3. The apparatus of claim 1 wherein the stream weight is based on a beamforming weight and a phase shift based on the circular-shift amount.

4. The apparatus of claim 1 wherein the stream weight is determined via array calibration being performed with cyclic-shift diversity.

5. The apparatus of claim 1 wherein the stream weight is determined via an uplink channel sounding that is circularly shifted at a receiver.

6. The apparatus of claim 1 wherein the stream weight is determined via downlink channel measurements made by a receiver from received pilot data with CSD applied.

7. A method comprising the steps of:
weighting a data stream with a stream weight;
performing an IFFT on the weighted data stream to produce a time-domain data stream;
circularly shifting the time-domain data stream by a circular-shift amount; and
transmitting the circular-shifted, time-domain data stream.

8. The method of claim 7 wherein the step of weighting the data stream with the stream weight comprises the step of:
weighting the data stream with a stream weight that is based upon the circular-shift amount.

9. The method of claim 7 wherein the stream weight is determined based on a beamforming weight and a phase shift based on the circular shift amount.

10. The method of claim 7 wherein the stream weight is determined via array calibration being performed with cyclic-shift diversity.

11. The method of claim 7 wherein the stream weight is determined via an uplink channel sounding that is circularly shifted at a receiver.

12. The method of claim 7 wherein the stream weight is determined via downlink channel measurements made by a receiver from received pilot data with CSD applied.

13. A method comprising the steps of:
performing a plurality of IFFT operations on data streams to produce a plurality of time-domain antenna streams;
circularly shifting at least one time-domain antenna stream by a circular shift amount;
transmitting the time-domain antenna streams via a plurality of antennas; and
wherein the data streams are mapped to OFDM sub-carriers according to a Partial Usage of Subchannels (PUSC) methodology described in the IEEE 802.16 specification.

14. The method of claim 13 wherein the step of transmitting the time-domain antenna streams via the plurality of antennas comprises the step of transmitting the antenna streams such that each antenna is transmitting the antenna stream with a particular and unique circular shift amount.
